(19) United States
(12) Patent Application Publication
(10) Pub. No.: US 2008/0135116 A1
(43) Pub. Date: Jun. 12, 2008

(54) Fluid manifolds

(75) Inventors: Hiroyuki Sugiura, Nagoya-Shi (JP); Masato Fukagaya, Nagoya-Shi (JP)

Correspondence Address: LAHIVE & COCKFIELD, LLP, ONE POST OFFICE SQUARE, BOSTON, MA, 02109-2127, US

(73) Assignee: Takasago Electric, Inc., Aichi-ken (JP)

(21) Appl. No.: 11/895,889

(22) Filed: Aug. 28, 2007

(30) Foreign Application Priority Data
Aug. 28, 2006 (JP) 2006-231414

(51) Int. Cl. F15B 13/02; B21D 51/00

(52) U.S. Cl. 137/596; 29/428

(57) ABSTRACT

Disclosed is a durable fluid manifold easy to handle and whose members for forming channels are thin and circuit volume is relatively small. The fluid manifold includes an admission-side base with fluid admission ports and an exhaust-side base with fluid exhaust ports. The fluid manifold additionally includes a flexible member made of a plurality of resin films bonded together by application of heat and pressure without using an adhesive. The flexible member is bonded on the upper surface of the bases and to form the fluid manifold, in which pumps and valves are mounted on the admission-side base via the flexible member. Formed within the flexible member are fluid channels placed in communication with the admission ports and the exhaust ports and coupled to the pumps and the valves.

### FIELD OF THE INVENTION

The present invention relates to fluid manifolds for constituting fluid circuits.

### BACKGROUND OF THE INVENTION

Conventionally, in various analytical systems, fluid circuit units have been employed in combination with different devices and equipments, such as chemical examination equipment, environmental analysis equipment, and bioengineering research equipment. Such a fluid circuit unit typically includes a fluid manifold for forming a fluid circuit and fluid control devices, such as pumps and valves, connected to the fluid manifold so as to supply liquid or gaseous sample fluids from a tank to reactors or detectors via the fluid manifold. In fluid manifolds of this type, in order to improve the accuracy of analysis and the examination speed, supply minute quantities of samples and reagents, and miniaturize the devices, various technologies have been proposed to reduce the internal volumes of the manifolds by reducing the sizes of the fluid control devices and shortening the fluid channels.

To attain the foregoing objectives, a number of analysis equipments fabricated by micromachining techniques are known, such as MEMS (micro electro mechanical systems). Japanese Published Unexamined Patent Application No. 2006-112836 discloses a microreactor fabricated by forming a groove having a width of 0.1 to 3000 μm at the interface between two substrates that are bonded with an adhesive to form a microchannel at the interface. Japanese Published Unexamined Patent Application No. 2004-85506 discloses a chemical analysis equipment including laminated substrates of transparent material, such as glass, polycarbonate, and acrylic, having a thickness of about 3 mm and fluid channels formed at the interfaces of the laminated substrates.

While these arrangements achieve their intended objectives, they are not free from certain problems and inconveniences.

For example, as fluid manifolds fabricated by micromachining can supply sample fluids only at extremely low flow rates, they may be suitable only for use in research laboratories but not for general users. Moreover, as feeding sample fluids through microchannels at microflow rates requires high pressure, high-power pumps and valves, such fluid control devices and thus the entire fluid circuit unit tend to be large. This defeats the purpose of miniaturization and makes the device more costly.

In view of the above-identified problems, a fluid circuit unit 101 shown in FIGS. 18 and 19 has been proposed. The fluid circuit unit 101 includes a manifold 102 and fluid control devices, such as pumps 103 and valves 104, mounted on the manifold 102, such that the entire unit has a three-dimensional shape. The manifold 102 includes upper and lower rectangular substrates 105 and 106 made of an acrylic resin. Fluid channels 107 are grooved in the upper surface of the lower substrate 106, while sample fluid inlets 108 and outlets 109 are provided on the opposing end faces of the lower substrate 106. The substrates 105 and 106 can be bonded together with screws and intermediate rubber elements or an adhesive, or by welding or any other suitable method. This construction permits integration of the fluid channels 107 and the fluid control devices 103 and 104 on the manifold 102, thus providing the entire fluid circuit unit 101 inexpensively and in a small size while allowing general users to easily handle proper amounts of sample fluids.

### Problems to Be Solved by the Invention

Although providing solutions to at least some of the foregoing problems, the conventional fluid circuit unit 101 suffers from the following deficiencies:

(1) A relatively large pressure is applied to the substrates 105 and 106 during the manufacture of the fluid manifold 102. Accordingly, the substrates 105 and 106 need to be rather thick to prevent damage, limiting the extent to which the size and weight of the manifold 102 can be reduced.

(2) The rigidity of the manifold 102 increases with the thickness of the substrates, which may in turn present certain inconveniences in handling and use of the manifold 102. For example, the added rigidity may make it impossible to bend and mount the manifold 102 on examination equipment with significant curvature.

(3) Since the fluid channels 107 are formed at the interface or junction between the substrates 105 and 106, the distances between the fluid channels 107 and the respective pumps 103 and valves 104 increase correspondingly to the increased thickness of the upper substrate 105. This disadvantageously increases the circuit volume of the manifold 102 and thus the amounts of the samples and reagents required.

(4) The distance is long between the upper surface of the upper substrate 105 and the reaction accelerator portion (the sinuous or serpentine part) 110 in the fluid channels 107. Accordingly, to facilitate the reaction of the reagents by heating the sample fluids, this structure reduces the heat transfer efficiency and the rate of reaction that occurs within the manifold 102.

(5) If heating is applied to only one side of the manifold 102, a temperature difference arises between the substrates 105 and 106, which undergo repeated cycles of expansion and contraction. This may result in detachment of the substrates 105 and 106 at the interface and thus shortens the life of the manifold 102.

(6) If bonding the substrates 105 and 106 via rubber members, variations in the fastening force among the screws and in the thickness of the rubber members may cause portions of the rubber members to protrude into the fluid channels 107 and thus block the flow of the sample fluids.

(7) This additionally requires a relatively large cross section of the fluid channels 107 and thus increases the circuit volume.

(8) Rubber members can be only thinned so much. Some types of rubber material do not have sufficient levels of chemical resistance and those with a high chemical resistance tend to be expensive and unsuitable for mass production.

(9) If the substrates 105 and 106 are glued together, the adhesive tends to protrude into the fluid channels 107 during the manufacture of the manifold 102, which in turn requires a larger cross section of the channels 107 and increases the circuit volume.

(10) If an adhesive is used for the fabrication of the manifold 102, some components of the adhesive may be released into the fluids in the circuit, potentially contaminating the fluid and/or affecting the accuracy of the examination or analysis depending on the type of the sample fluid.

(11) If the substrates 105 and 106 are welded together, the types of material that may be used for the manifold 102 are limited to resins with a relatively low melting point, such as acrylic resins and polycarbonate resins.

(12) Since neither acrylic resins nor polycarbonate resins have a high chemical resistance, such a manifold 102 will have only a limited range of applications.

### SUMMARY OF THE INVENTION

An important object of the present invention is to provide a solution to the problems identified above and in particular provide a durable fluid manifold that is easy to handle and whose members for forming channels are thin and circuit volume is relatively small.

### Means to Solve the Problems

To solve the above-identified problem, the present invention provides a fluid manifold comprising a flexible member including a plurality of films bonded together by application of heat and pressure without use of any adhesive. The flexible member further includes at least one fluid inlet, at least one fluid outlet, and at least one fluid channel, the at least one fluid channel connecting the at least one fluid inlet to the at least one fluid outlet.

For example, the foregoing fluid manifold may be connected to external fluid control devices (such as a suitable number of pumps and valves) or include such fluid control devices mounted on the manifold itself when used as part of systems for analyzing and examining sample fluids. In one aspect, the foregoing fluid manifold may be employed as bonded or joined onto a highly rigid base or bases. Preferred materials for the films of the flexible member include resins with high flexibility and excellent chemical and heat resistance, such as polyimides or polyether ether ketone (PEEK) resin. It should be noted, however, that the materials for the films are not limited to resins but may be chosen from a wide range of metals, including but not limited to copper and nickel, that are compatible with the chemical properties of the fluids to be used in the manifold.

In another aspect, the fluid manifold further comprises at least one base attached to a surface of the flexible member. Furthermore, the at least one fluid channel is formed within the flexible member, and the base includes at least one admission port placed in communication with the at least one fluid inlet in the flexible member and at least one exhaust port placed in communication with the at least one fluid outlet in the flexible member.

A preferred method of fabricating the flexible member includes providing the fluid channels in at least one of the resin films and bonding the resin films together by application of heat and pressure without use of any adhesive. Preferred materials for the films include but are not limited to polyimides and PEEK resins. The materials for the flexible member, however, are not limited to resins but also include a plurality of films made of metal laminated with the fluid channels formed in at least one of the films. Such metal films may be made of a range of metals, including but not limited to copper and nickel, compatible with the chemical properties of the fluids to be used in the manifold.

In still another aspect, the fluid manifold further comprises at least one base to a surface of which the flexible member is bonded by application of heat and pressure without using any adhesive. The at least one base may include at least one admission port placed in communication with the at least one fluid inlet of the flexible member and at least one exhaust port placed in communication with the at least one fluid outlet of the flexible member. In one embodiment, the at least one fluid channel is formed within the flexible member. Alternatively, the at least one fluid channel may be formed between the flexible member and the at least one base.

When formed at the interface between the two elements as described above, the at least one fluid channel may be formed in the flexible member or the at least one base, or in both elements. To suit mass-production of a fluid circuit unit that employs any of the fluid manifolds described above, preferably, the at least one fluid channel is formed in the surface of the at least one base, and the flexible member, such as a resin film, is bonded to the surface of the at least one base by heat and pressure application to cover the at least one fluid channel. Preferred materials for the at least one base include resins with excellent chemical and heat resistance, such as polyimide and polyether ether ketone (PEEK) resins. The resin film may have a single- or plural-layer structure and is preferably made of the same material as the at least one base to facilitate the heat and pressure bonding.

In a further aspect, the present invention provides an arrangement for unitizing a fluid manifold so as to further reduce the fluid volume of the fluid manifold. The foregoing arrangement is characterized by fluid control devices mounted on the flexible member. Preferably, the fluid control devices include valve members for opening and closing the at least one fluid channel and the flexible member includes valve seats thereon for receiving the valves. Examples of the fluid control devices according to the present invention include without limitation valves employing solenoids or piezoelectric elements, whereas preferred examples of the valve members include diaphragm valves. Each valve seat can be easily provided on the flexible member by forming an opening having approximately the same size as the valve member in the uppermost layer film.

In another aspect, in a fluid manifold including fluid control devices on its flexible member, the present invention provides an arrangement for simplifying the electric wiring of the fluid control devices. The foregoing arrangement is characterized by providing a wiring pattern forming the electric wiring of the fluid control devices on the flexible member. The wiring pattern may be provided either on the top surface, i.e., the surface-layer film of the flexible member or inside the flexible member, i.e., in/on an intermediate film thereof so as to electrically insulate the pattern. Moreover, in addition to the valves, other types of fluid control devices, including fluid sensors and heater elements, may be mounted on the wiring pattern.

In one aspect, the at least one base includes a first base containing the at least one admission port and a second base containing the at least one exhaust port.

In a further aspect, the flexible member is adapted to be detachable from the second base by bending the flexible member while the remainder of the fluid manifold is substantially stationary. This permits, for example, replacement of the second base while the fluid manifold remains on the surface where it is placed.

The present invention is additionally directed to a method for manufacturing a fluid manifold. The method comprises the steps of: bonding a plurality of films by application of heat and pressure without use of any adhesive to form a flexible member, and providing at least one fluid inlet, at least one fluid outlet, and at least one fluid channel in the flexible member, the at least one fluid channel connecting the at least one fluid inlet to the at least one fluid outlet.

In one aspect, this method further comprises the step of attaching a surface of the flexible member to at least one base including at least one admission port and at least one exhaust port. When assembled, the at least one admission port is placed in communication with the at least one fluid inlet and at least one exhaust port is placed in communication with the at least one fluid outlet.

### EFFECT OF THE INVENTION

According to certain fluid manifolds of the present invention, since the flexible member is fabricated from a plurality of films without use of any adhesive, the fluid channels are not narrowed or clogged by adhesive, thus advantageously minimizing the cross sectional area of the channels and the circuit volume. Furthermore, since no adhesive is dissolved into the fluids, the manifolds according to the present invention may be advantageously employed to feed sample fluids containing specimens in particular. Since the at least one fluid channel is provided in/on the flexible member, the manifold can be easily bent to facilitate its handling in an examination/analytical system, such as its removable attachment to various inspection equipment and devices.

Additionally, according to the fluid manifolds of the present invention, since a flexible member containing at least one fluid channels is bonded to a surface of a base, the flexible member is advantageously integrated with the base and, as required, fluid control devices may be easily mounted on the flexible member. This facilitates the size reduction and enhances the functionality of fluid circuit units incorporating such a fluid manifold. Since the distance between the surface of the flexible member and the internal fluid channels is relatively short, the rate of reaction of sample fluids can be increased, especially when the sample fluids are heated for reaction. As an additional advantage, the flexible member has sufficient bendability for its effortless coupling to various equipments and devices, such as those for inspection and examination.

Moreover, according to the fluid manifolds of the present invention, since a flexible member is bonded to a surface of the base by such simple means as application of heat and pressure, the flexible member is easily integrated with the base, thus facilitating the size reduction and enhancing the functionality of fluid circuit units incorporating such a fluid manifold. In particular, if the at least one fluid channel is to be formed in the base, the base and the at least one fluid channel may be molded or otherwise formed simultaneously, facilitating mass production of the fluid manifold.

### BRIEF DESCRIPTION OF THE ATTACHED DRAWINGS

For a fuller understanding of the nature and objects of the present invention, reference should be made to the following detailed description and the accompanying drawings, in which:

FIG. 1 is a perspective view of a fluid circuit unit according to a first embodiment of the present invention;

FIG. 2 shows a plan view of the fluid circuit unit in FIG. 1;

FIG. 3 shows a fluid circuit diagram of the unit in FIG. 1;

FIG. 4 shows cross sectional views of different parts of the fluid circuit unit in FIG. 1;

FIG. 5 shows a plan view of the different elements constituting the flexible member of the fluid circuit unit in FIG. 1;

FIG. 6 shows a perspective view of the fluid manifold of the fluid circuit unit in FIG. 1;

FIGS. 7a and 7b are elevation views of the fluid circuit unit in FIG. 1, showing a manner of use thereof;

FIG. 8 is a perspective view of a fluid circuit unit according to a second embodiment of the present invention;

FIG. 9 shows a plan view of the fluid circuit unit in FIG. 8;

FIG. 10 shows cross sectional views of different parts of the fluid circuit unit in FIG. 8;

FIG. 11 shows a plan view of the different elements constituting the flexible member of the fluid circuit unit in FIG. 8;

FIG. 12 is a perspective view of a fluid circuit unit according to a third embodiment of the present invention;

FIG. 13 shows a plan view of the fluid circuit unit in FIG. 12;

FIG. 14 shows an electrical circuit diagram of the fluid circuit unit in FIG. 12;

FIG. 15 shows cross sectional views of the valve and the flexible member, in three states, of the fluid circuit unit in FIG. 12;

FIG. 16 shows a plan view of the different elements constituting the flexible member of the fluid circuit unit in FIG. 12;

FIG. 17 shows an alternate valve and an alternate flexible member of the present invention;

FIG. 18 is a perspective view of a conventional fluid circuit unit; and

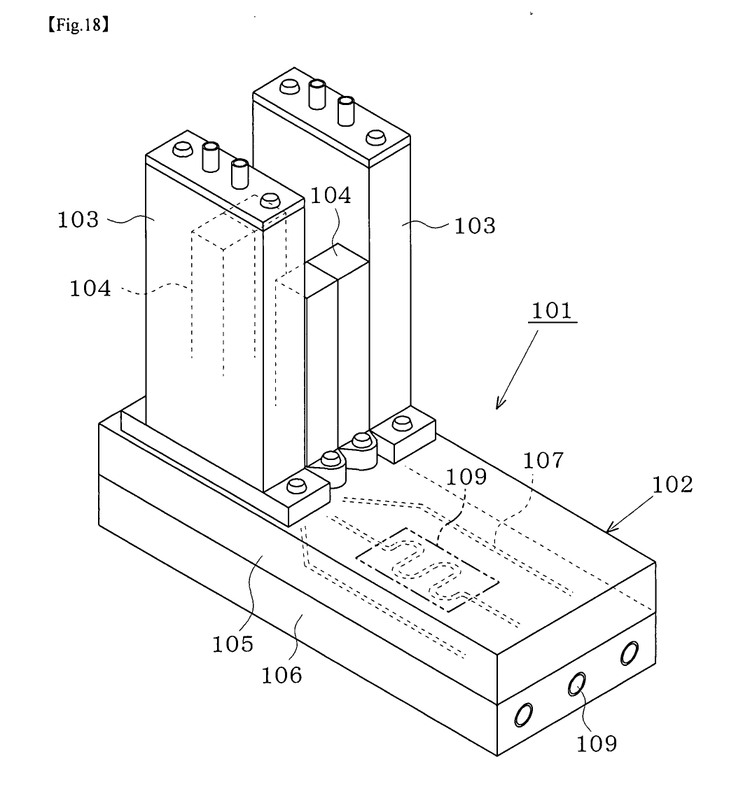

FIG. 19 is an exploded perspective view of the substrates of the fluid circuit unit in FIG. 18, showing the fluid channels provided in the substrates.

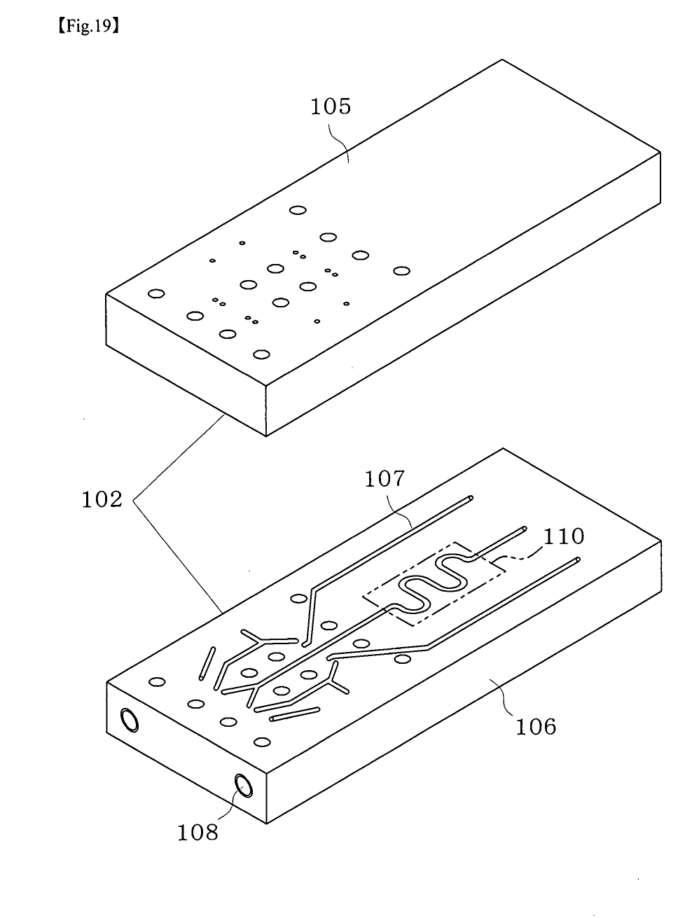

### DETAILED DESCRIPTION OF THE PREFERRED EMBODIMENTS OF THE INVENTION

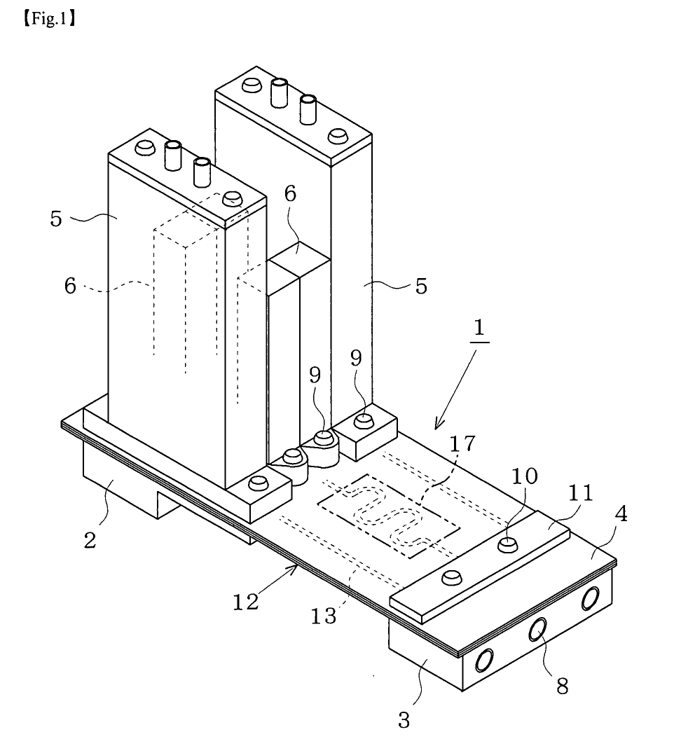

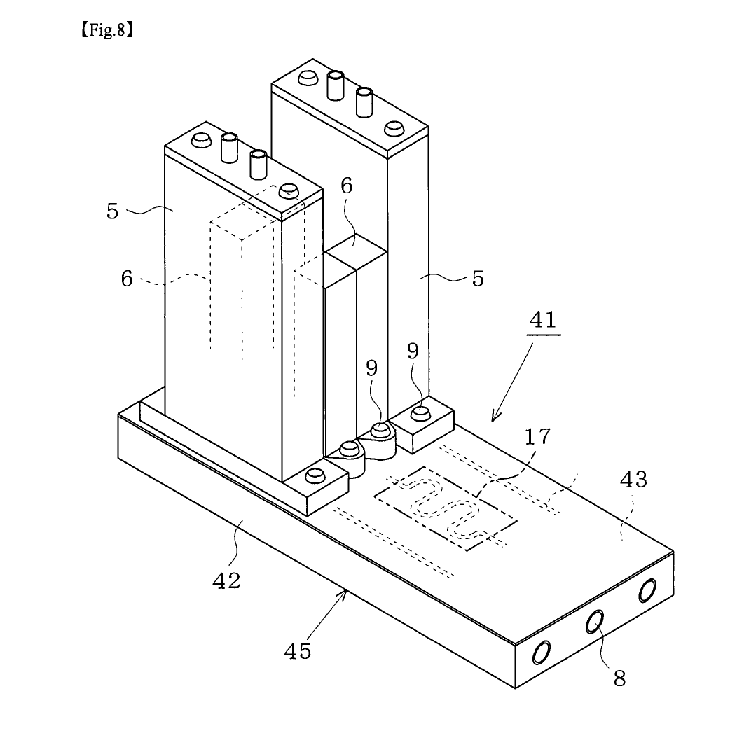

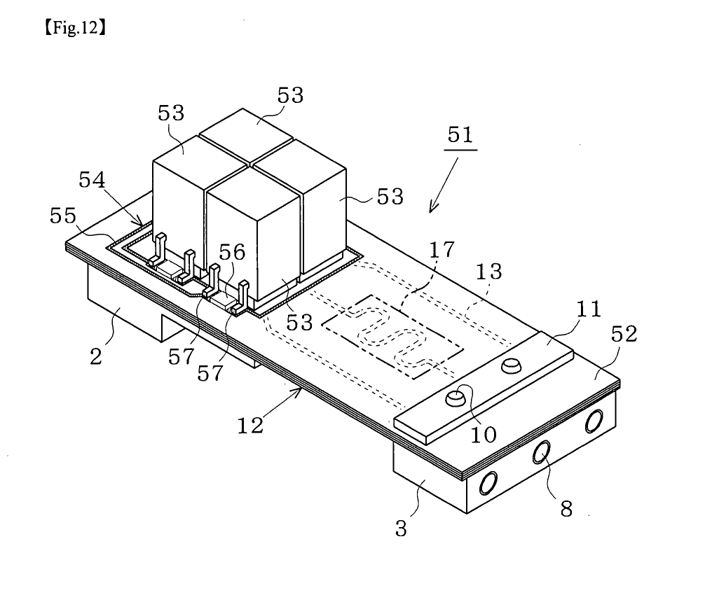

Preferred embodiments of the present invention will be described hereinafter with reference to the attached drawings. FIGS. 1 to 7 show a first embodiment of a fluid circuit unit 1, in which fluid channels or passages 13 for supplying sample fluids are formed within a fluid manifold 12. FIGS. 8 to 11 show a second embodiment of a fluid circuit unit 41, in which fluid channels 13 are formed between a base 42 and a flexible member 43. FIGS. 12 to 16 show a third embodiment of a fluid circuit unit 51, in which a valve seat 66 for receiving the diaphragm 60 of each valve 53 and a wiring pattern 55 for a electrical circuit 54 for the valves are disposed on a flexible member 52. It should be noted that similar elements are denoted by similar reference numerals throughout the various views.

### Embodiment 1

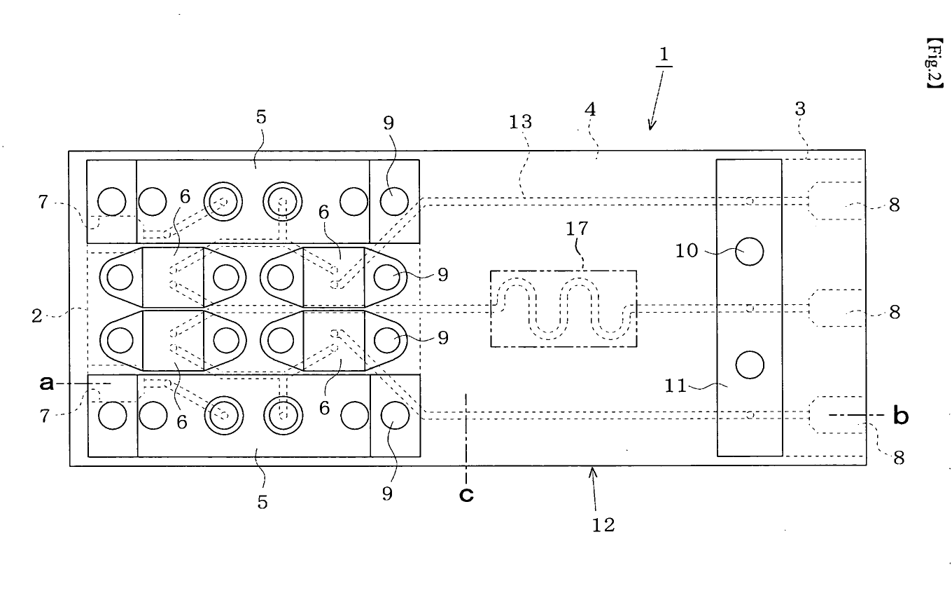

As shown in FIGS. 1 and 2, the fluid circuit unit 1 of the first embodiment includes split bases 2 and 3, a flexible member 4 pressure and thermal bonded to the top surfaces of the split bases 2 and 3, and fluid control devices, such as pumps 5 and valves 6, disposed on the top surface of the flexible member 4. One of the bases, the base 2, includes a pair of admission ports 7 for introducing different types of sample fluids, while the other base, the base 3, includes three exhaust ports 8 for discharging the sample fluids introduced. Additionally, two micropumps are used as the pumps 5, whereas four small-sized diaphragm valves are used as the valves 6. The pumps 5 and the valves 6 are mounted on the fluid admission-side base 2 with screws 9 that penetrate the flexible member 4 in the fluid admission end of the flexible member. The other end of the flexible member 4 is attached to the exhaust-side base 3 with a pair of screws 10 via a support plate 11.

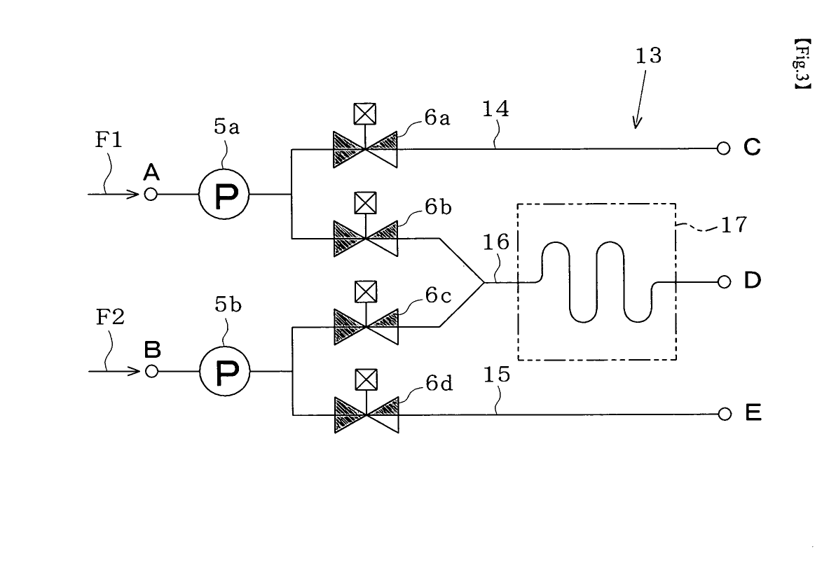

Formed within the flexible member 4 are fluid channels 13 placed in communication with the admission ports 7 and the exhaust ports 8. As best shown in FIG. 3, the fluid channels 13 include a first channel 14 for supplying a first fluid F1 from an inlet port A to an outlet port C via a pump 5a and a valve 6a; a second channel 15 for supplying a second fluid F2 from an inlet port B to an outlet port E via a pump 5b and a valve 6d; and a third channel 16 for supplying either one of the first and second fluids F1, F2 or both fluids as a mixture from the inlet ports A, B to an outlet port D via the pumps 5a, 5b and the valves 6b, 6c. Furthermore, a reaction accelerator portion (the sinuous or serpentine part) 17 is formed intermediately in the third fluid channel 16 so as to accelerate the mixed fluids by application of heat. For this purpose, an external heater (not shown) is provided to apply heat to the region of the flexible member 4 that encompasses or corresponds to the reaction accelerator portion 17.

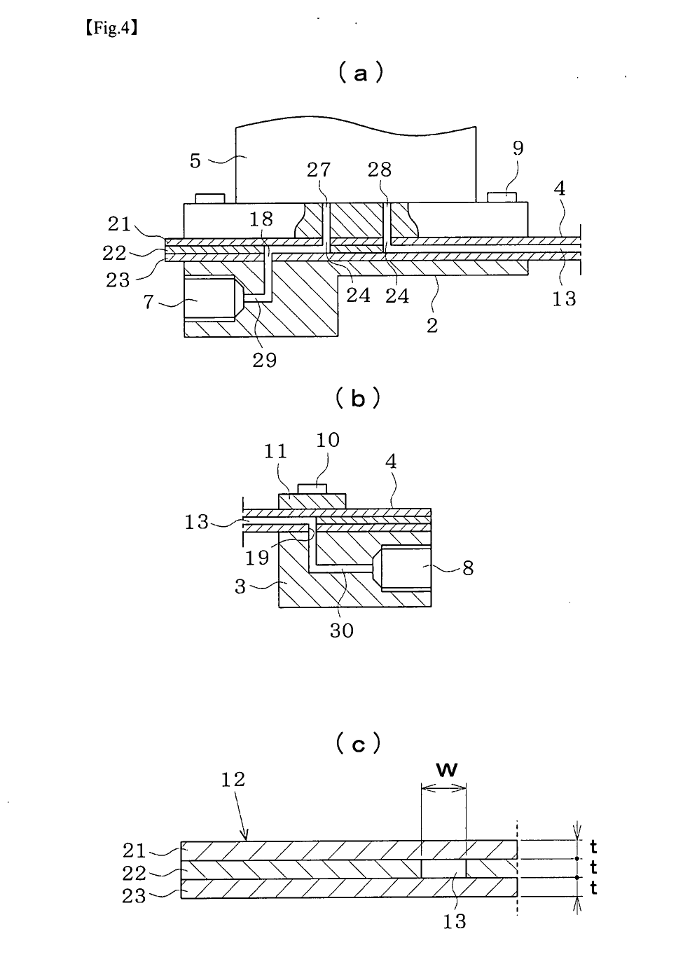

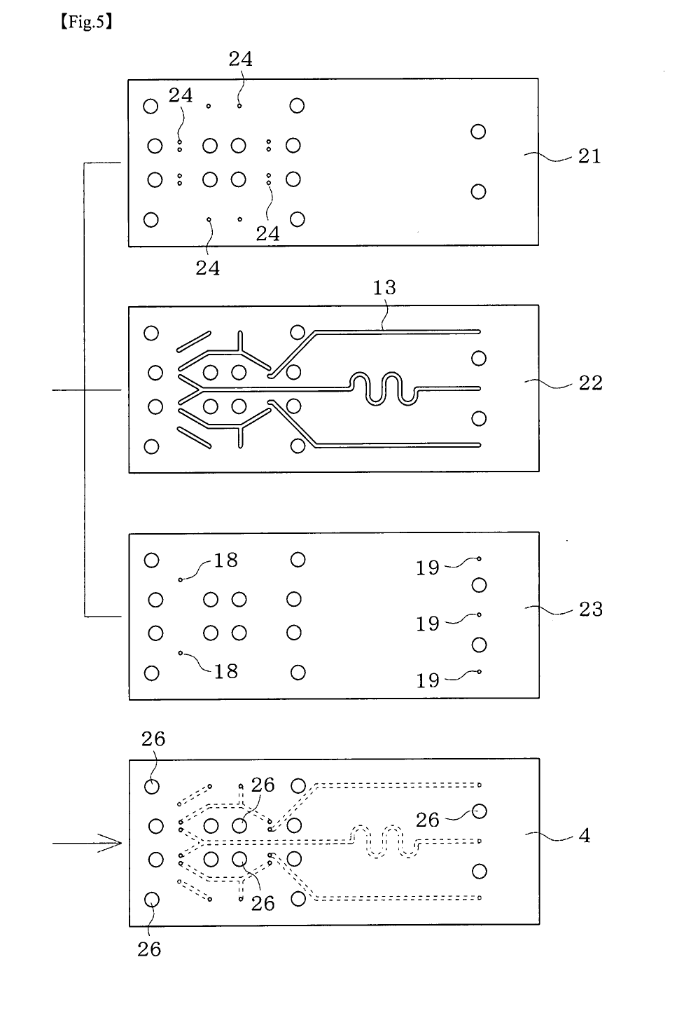

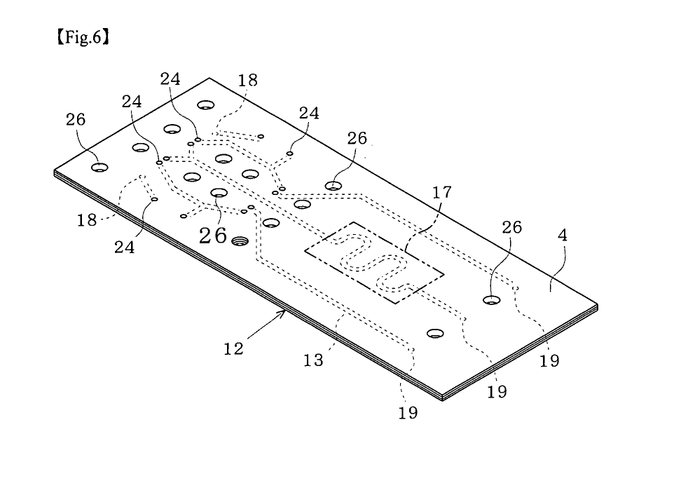

Turning to FIGS. 4 and 5, three layers of resin films 21, 22, and 23 are joined to constitute the flexible member 4 by heat and pressure bonding without using any adhesive. The intermediate resin film 22 includes the fluid channels 13 formed, for example, by laser, water jetting, etching, or any other suitable method or means. Connecting holes 24 are made in the upper resin film 21 so as to connect the fluid channels 13 to the pumps 5 and the valves 6. The lower resin film 23 includes fluid inlets 18 for coupling to the admission ports 7 of the base 2 and fluid outlets 19 for coupling to the exhaust ports 8 of the base 3 when these elements are assembled. The resin films 21, 22, and 23 are bonded to constitute the flexible member 4, in which through holes 26 are made so as to receive screws 9 and 10 for mounting the pumps 5, the valves 6, and the support plate 11 to fabricate the fluid manifold 12 shown in FIG. 6. In the fluid manifold 12, the inlets 18 are placed in communication with the outlets 19 via the fluid channels 13.

FIGS. 4a, 4b, and 4c are cross sectional views taken along lines a, b, and c of FIG. 2. Each pump 5 has an admission port 27 and an exhaust port 28 in communication with connecting holes 24 in the upper resin film 21, while each valve 6 has a similar admission port and an exhaust port (not shown). The admission-side base 2 includes admission channels 29 formed therethrough for connecting the admission ports 7 to the fluid inlets 18 of the manifold 12, while the exhaust-side base 3 includes exhaust channels 30 formed therethrough for connecting the fluid outlets 19 to the exhaust ports 8 of the manifold 12. The bases 2 and 3 are made of PEEK and the resin films 21, 22, and 23 are made of polyimide. Both of the materials have excellent chemical and heat resistance. Each of the three films have a thickness t of approximately 0.25 mm, the fluid channels have a width w of approximately 0.5 mm and the fluid channels are designed to have approximately the same cross-sectional area as that of a circular channel with a diameter ø of 0.4 mm.

A fluid circuit unit 1 constructed as above provides the following effects and advantages:

(1) The fluid channels 13, being provided within the flexible member 4, shorten the distance between the fluid channels 13 and the pumps 5 and the valves 6, reduces the circuit volume of the fluid manifold 12, and saves the amount of sample fluid used.

(2) Since the distance is relatively short between the upper surface of the manifold 12 and the reaction accelerator portion 17, rapid thermal conduction occurs so as to increase the rate of reaction between the mixed fluids and the temperature of the mixed fluids can be accurately controlled when conducting thermal reaction between the sample fluids.

(3) Since the three resin films 21, 22, and 23 are uniformly and equally heated, separation or detachment is unlikely to occur at the interfaces between the films, thus prolonging the life of the manifold 12.

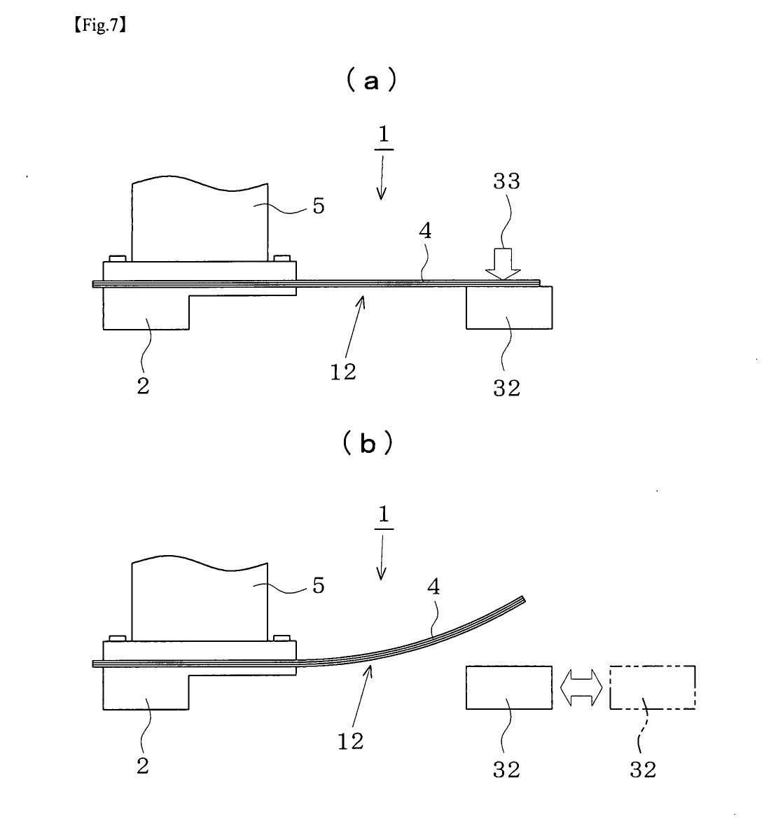

(4) Since the manifold 12 is highly flexible, the fluid circuit unit 1 lends itself to attachment to peripheral or associated equipment in a curved state. With specific reference to FIG. 7a, an examination block 32 may be substituted for the exhaust-side base 3 in the fluid circuit unit 1. The manifold 12 may be coupled to the examination block 32 by pressure coupling the exhaust-side end of the manifold 12 to the block 32 with an actuator, such as an air cylinder 33, in a fluid-tight manner. Sample fluids may then be supplied into the block 32 for subsequent examination. Once the examination is completed, the actuator 33 is operated to remove the biasing force from the manifold 12, so that a robot arm or a human operator can bend and take the manifold 12 off the examination bock 32 to substitute the next block 32. In this way, the admission-side base 2 may remain stationary while the exhaust-side end of the manifold 12 is readily attached to and removed from examination blocks 32. This convenient feature facilitates automation of processes particularly in an examination system that requires a separate block 32 for each sample.

(5) Since the resin films 21, 22, and 23 are bonded together by application of heat and pressure, no rubber elements or adhesive is pushed out into the fluid channels 13, the cross-sectional area of the fluid channels 13 is minimized, and the circuit volume of the manifold 12 is reduced.

(6) Since the fabrication of the manifold 12 eliminates the need for an adhesive, no adhesive components are dissolved or released into the fluid channels, thus preventing adverse effects on the accuracy of examinations.

(7) The three-layer structure of the manifold 12 ensures that the upper and lower films 21 and 23 easily and securely seal the fluid channels 13 in the intermediate resin film 22.

(8) The fluid channels 13 can be formed by laser or water jetting for low-volume production and by etching for mass production, both easily and inexpensively.

(9) Since the three resin films 21, 22, and 23 are made of polyimide films, the manifold 12 has superior chemical and heat resistance and finds a wide range of applications.

### Embodiment 2

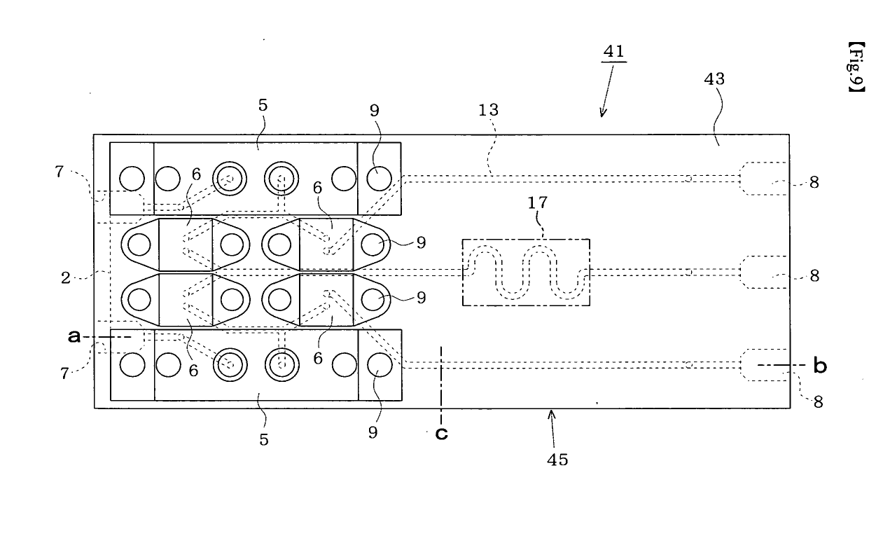

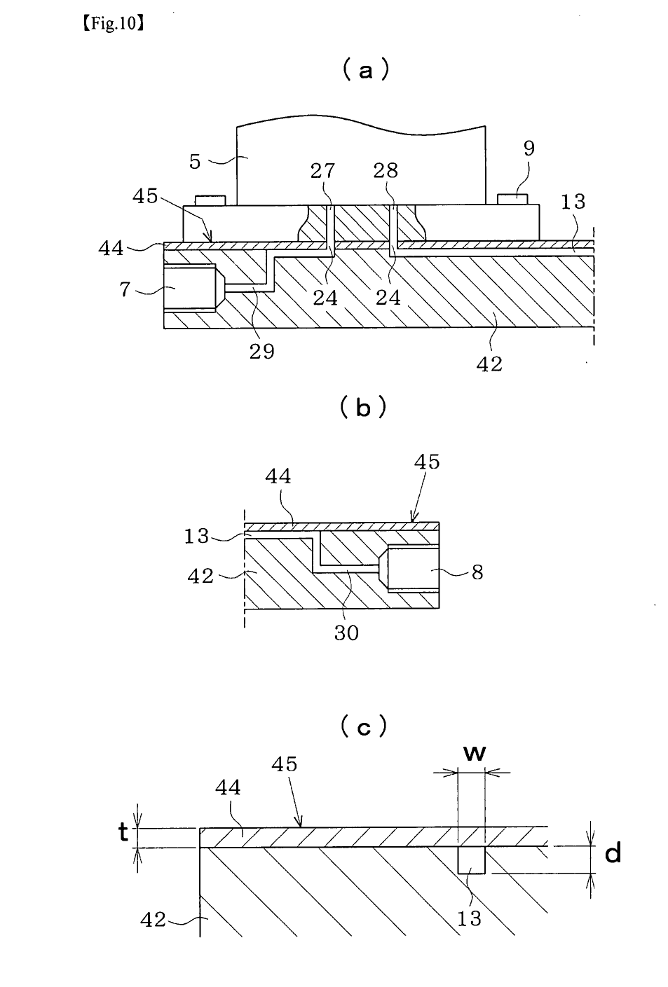

As shown in FIG. 8, the fluid circuit unit 41 of the second embodiment includes a one-piece, tabular base 42, a flexible member 43 bonded to the top surface of the base 42, and pumps 5 and valves 6, serving as the fluid control devices, mounted on the flexible member 43. Turning now to FIGS. 9 and 10, the base 42 includes admission ports 7 on one end thereof and exhaust ports 8 on the other end, with fluid channels 13 machined or molded in the surface of the base 42 to permit flow of sample fluids therein. It should be noted that those skilled in the art may recognize other suitable methods of providing the fluid channels 13 in addition to the above which fall within the scope of the present invention. The fluid channels 13 of the fluid circuit unit 41 according to this embodiment are identical to those of the first embodiment (see FIG. 3) with the ends of the channels 13 placed in communication with the admission ports 7 and the exhaust ports 8 in the base 42. A single resin film 44 is used as the flexible member 43, which is heat and pressure bonded to the top surface of the base 42 without using an adhesive to cover the fluid channels 13.

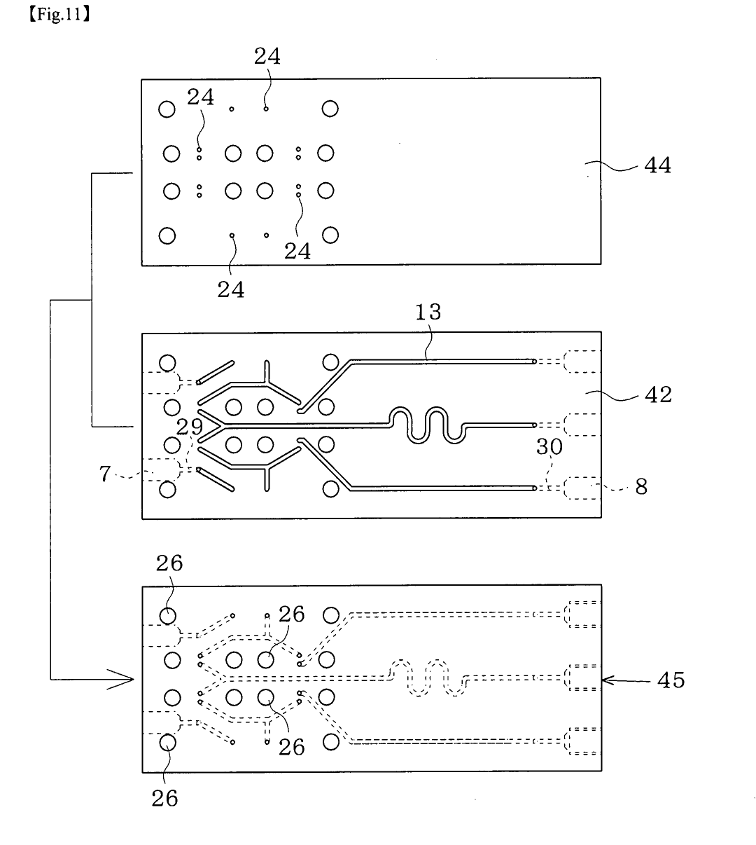

Turning now to FIGS. 10 and 11, the base 42 includes admission channels 29 formed therein for placing the admission ports 7 in communication with the fluid channels 13. The base 42 additionally includes exhaust channels 30 formed therein for placing the fluid channels 13 in communication with the exhaust ports 8. Connecting holes 24 are made in the resin film 44 so as to connect the channels 13 to the admission ports 27 and the exhaust ports 28 of the pumps 5 and the valves 6. To fabricate the fluid manifold 45, the resin film 44 is bonded to the base 42 and screws 9 are tightened into the holes in the identical locations of the resin film 44 and the base 42 so as to mount the pumps 5 and the valves 6 on the fluid manifold 45. The base 2 and the resin film 44 are both made of PEEK, which has excellent chemical and heat resistance. The film 44 has a thickness t of approximately 0.25 mm, the fluid channels have a width w and a depth d of both approximately 0.35 mm and the fluid channels are designed to have approximately the same cross-sectional area as that of a circular channel with a diameter ø of 0.4 mm.

A fluid circuit unit 41 constructed as above provides the following effects and advantages:

(1) With the fluid channels 13 being provided between the base 42 and the flexible member 43, the distance between the fluid channels 13 and the pumps 5 and the valves 6 is shortened, thus reducing the circuit volume of the fluid manifold 45.

(2) The relatively short distance between the upper surface of the manifold 43 and the fluid channels 13 facilitates the heat conduction during the thermal reaction between the sample fluids so as to increase the rate of reaction between the fluids and enable accurately control of the temperature of the fluids.

(3) Since no significant temperature difference develops between the flexible member 43 and the base 42, separation or detachment is unlikely to occur at the interfaces between the flexible member 43 and the base 42, thus prolonging the life of the manifold 45.

(4) Since the flexible member 43 is bonded to the base 42 by application of heat and pressure, this structure requires no rubber elements or adhesive, minimizes the cross-sectional area of the fluid channels, and eliminates the possibility of any adhesive dissolving into the fluids.

(5) Since the fluid channels 13 are constructed by covering the top surface of the base 42 with the single resin film 44, the flexible member 43 can be manufactured at a lower cost than in the first embodiment.

(6) As the base 42 and the fluid channels 13 may be molded simultaneously, the manifold 45 can be mass produced easily.

(7) As the base 42 is a one-piece plate with high rigidity, the fluid circuit unit 41 is suitable for applications where the fluid channels 13 need to be held in a plane. This construction additionally reduces the overall number of parts of the fluid circuit unit 41.

### Embodiment 3

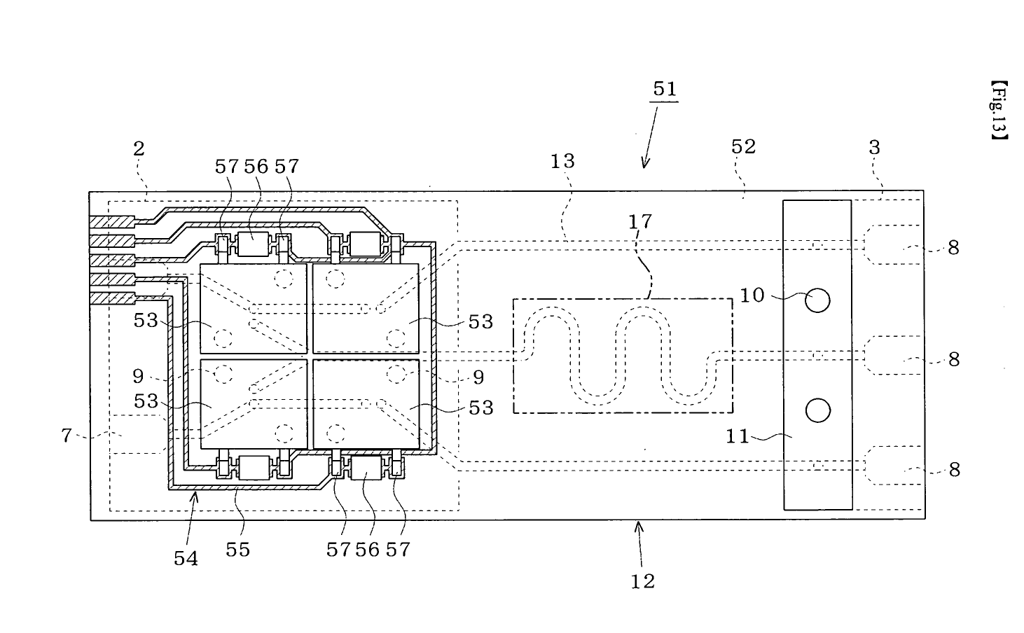

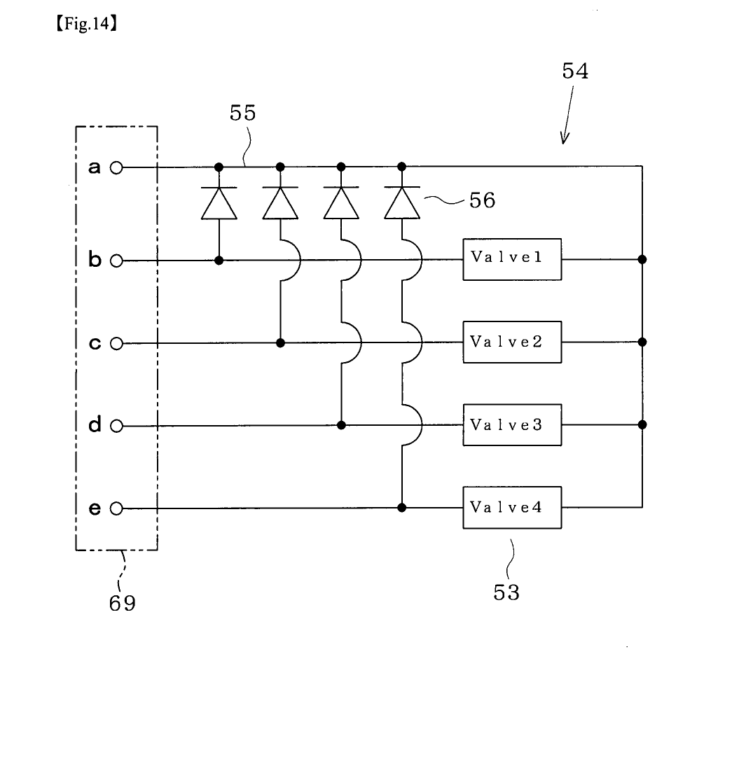

As shown in FIGS. 12 and 13, the fluid circuit unit 51 of the third embodiment includes split bases 2 and 3, a flexible member 52 heat and pressure bonded to the top surfaces of the split bases 2 and 3, and valves 53 disposed on the top surface of the flexible member 52. Formed inside the split bases 2 and 3 are admission ports 7 and exhaust ports 8, respectively, while fluid channels 13 placed in communication with the ports 7 and 8 are disposed within the flexible member 52. A copper wiring pattern 55 for an electrical circuit 54 (see FIG. 14) for the valves is disposed on the upper surface of the flexible member 52 and includes the same number of surge killer diodes 56 as the valves 53 soldered onto the pattern 55. Each valve 53 includes electrical contacts, such as pins 57 soldered on the pattern 55 in predetermined locations. It should be noted that this fluid circuit unit 51 does not include any pumps (as external pumps are used) and employs four diaphragm valves 53 that have a lower profile than the valves 6 of the first and second embodiments. The diaphragm valves 53 are mounted to the base 2 with screws 9.

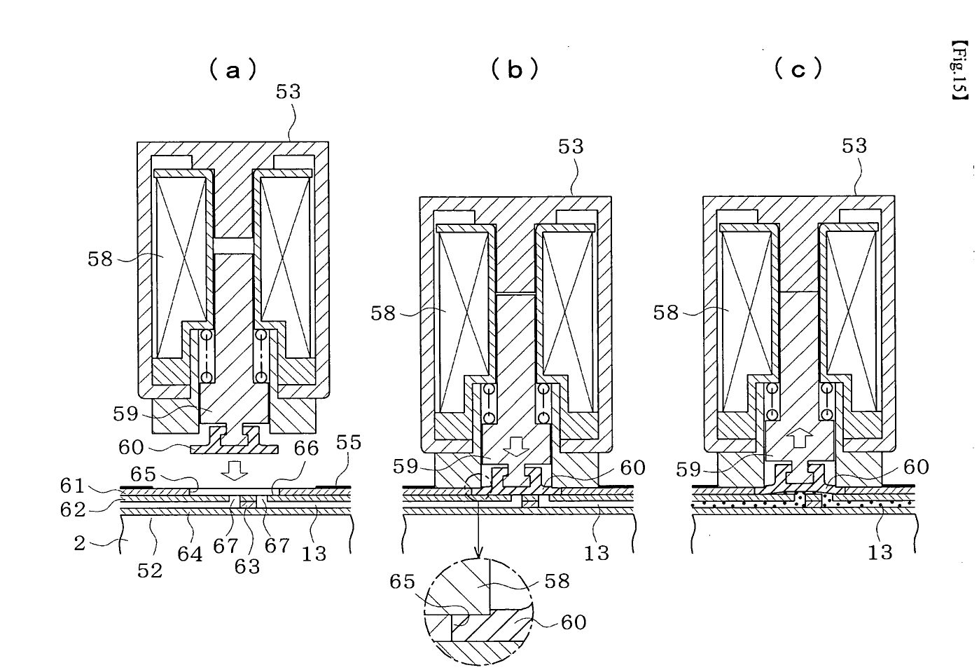

As shown in FIG. 15, each valve 53 includes a solenoid 58 and a plunger 59 with a valve element, such as a diaphragm 60, at the lower end of the plunger 59 for opening and closing the fluid channel 13. Four layers of resin films 61, 62, 63, and 64 are joined to constitute the flexible member 52 by heat and pressure bonding without using any adhesive. The upper resin film 61 includes openings 65 having approximately the same size as the diaphragms 60 and valve seats 66 for receiving the diaphragms 60 on the flexible member 52 via the openings 65. Each diaphragm 60 is made of a flexible material, such as rubber, slightly thicker than the resin film 61, such that when mounted on the flexible member 52, the solenoid 58 is capable of compressing the diaphragm 60 with the undersurface of the solenoid 58 (see the enlarged partial view in the circle) to seal the opening 65 against leakage of sample fluids.

FIG. 15a shows one of the valves 53 before being mounted on the flexible member 52. FIG. 15b shows the valve 53 mounted with the solenoid 58 demagnetized and the plunger 59 lowered, thus closing the fluid channel 13 with the diaphragm 60. FIG. 15c shows the valve 53 mounted with the solenoid 58 magnetized and the plunger 59 and the diaphragm 60 raised, thus opening the fluid channel 13.

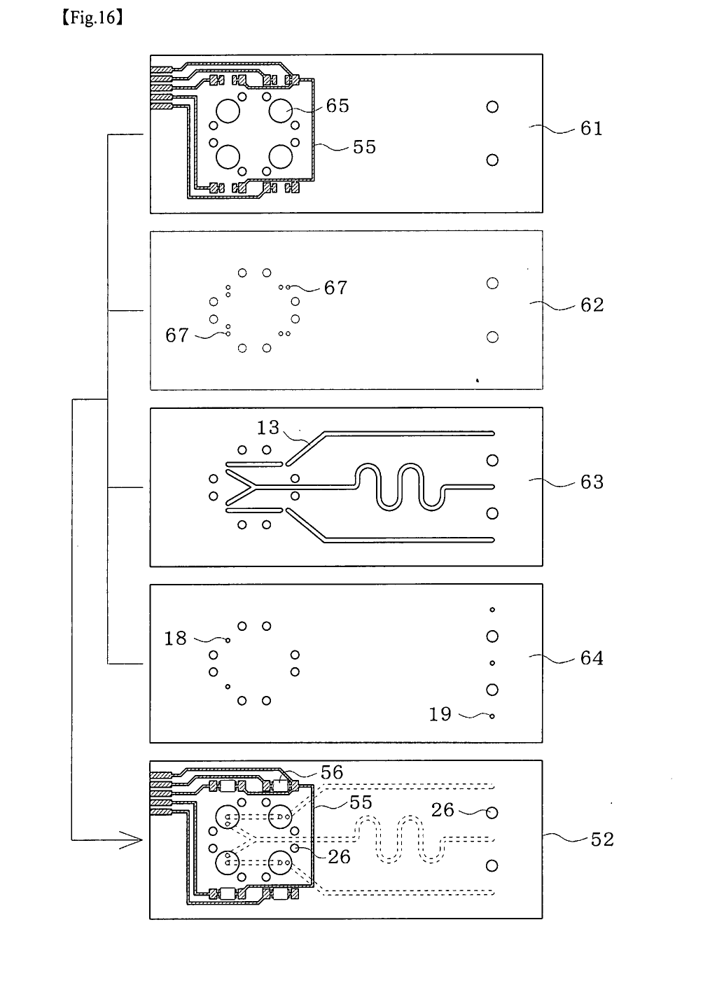

FIG. 16 shows the copper wiring pattern 55 and the openings 65 in the uppermost resin film 61 and additionally shows the second layer resin film 62 with connecting holes 67 in communication with the openings 65. In this way, the fluid channels 13 are coupled to the valves 53 via the connecting holes 67. The fluid channels 13 are formed in the third layer resin film 63 by laser, water jetting, etching, or any other suitable method or means. The lowermost resin film 64 includes fluid inlets 18 for coupling to the admission ports 7 of the base 2 and fluid outlets 19 for coupling to the exhaust ports 8 of the base 3 when these elements are assembled. The resin films 61 to 64 are bonded to form the flexible member 52, in which through holes 26 are made so as to receive screws 9 and 10 for mounting the valves 53 and the support plate 11 (see FIG. 12) to fabricate the fluid manifold 12, which has substantially the same structure as that of the first embodiment. In the fluid manifold 12, the inlets 18 are placed in communication with the outlets 19 via the fluid channels 13. The bases 2, 3 and the resin films 61 to 64 are made of PEEK or polyimide, and the fluid channels 13 of this embodiment have the same cross-sectional area as that of the first embodiment.

A fluid circuit unit 51 constructed as above provides the following effects and advantages, in addition to those provided by the first embodiment:

(1) Since the valve seats 66 for receiving the diaphragms 60 are provided on the flexible member 52, the valves 53 are capable of opening and closing the fluid channels 13 on the flexible member 52. This eliminates the need for channels that circulate sample fluids within the valves 53 (these channels would correspond to the admission ports 27 and the exhaust ports 28 in the first and second embodiments), further reducing the circuit volume.

(2) Since the foregoing arrangement does not allow sample fluids to flow into the valves 53, diaphragm valves, which tend to have smaller vertical dimensions than the valves 53, are employed in this embodiment, resulting in the lower overall height of the fluid circuit unit 51.

(3) Since the copper wiring pattern 55 forming the electrical circuit 54 for the valves is provided on the flexible member 52, there is no need to route lead wires to the solenoids 58, thus simplifying the electric wiring of the fluid circuit unit 51.

(4) As best shown in FIG. 14, since the five terminals a to e of the copper wiring pattern 55 converge to a connector 69 on one end of the fluid circuit unit 51, the valves 53 are readily connectable to a power source or a control unit.

(5) The copper wiring pattern 55 can be easily modified to implement complex electric circuitry on the flexible member 52 so as to improve the functionality of the fluid circuit unit 51. For example, in addition to the surge killer diodes 56, the wiring pattern 55 may mount other electronic elements for controlling the operation of the valves 53, such as drivers for preventing excessive heat generation in the solenoids 58 and drivers for latch type solenoids.

(6) It is equally easy for the copper wiring pattern 55 to accommodate various detectors, actuators, and/or other fluid control devices, such as magnetic sensors, optical sensors, temperature sensors, heaters, and piezoelectric elements, so as to further enhance the functionality of the fluid circuit unit 51. For example, part of the copper wiring pattern 55 may be coiled to implement a magnetic sensor for sensing fluids on the flexible member 52.

One of ordinary skill in the art will additionally appreciate that the above embodiments are only an illustration and not restrictive in any sense and that there are different ways to alter the parameters of the embodiments disclosed, such as the size, shape, or type of elements or materials, in a manner still in keeping with the spirit and scope of the present invention as set forth below.

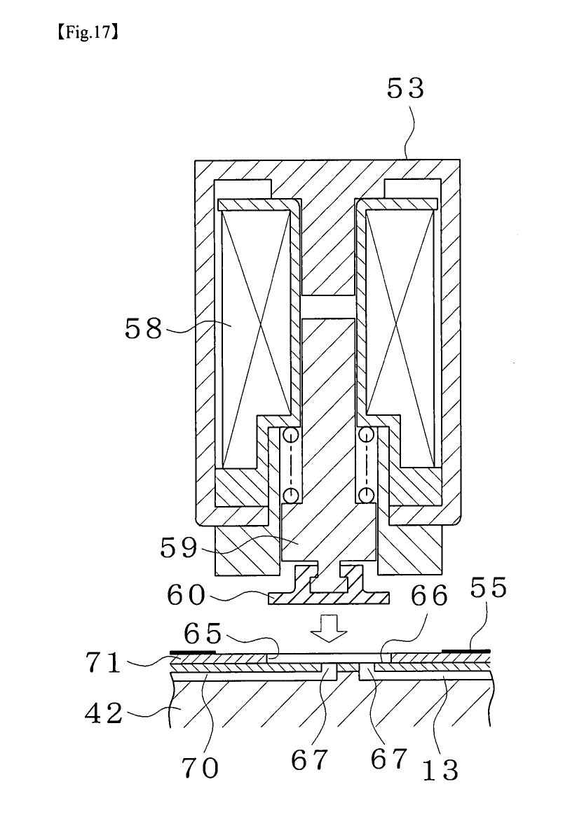

(a) For example, as shown in FIG. 17, certain features of the second and third embodiments may be combined to form fluid channels 13 in the upper surface of the base 42, cover the fluid channels 13 with a double-layer flexible member 70, form a copper wiring pattern 55 on the upper resin film 71 and the openings 65 in the film 71, attach a diaphragm 60 on the plunger 59 of each valve 53, and provide valve seats 66 for receiving the diaphragms 60 on the flexible member 70.

(b) In the fluid circuit unit 1 of the first embodiment, the flexible member 4 may be made of laminated copper or stainless steel films in which the fluid channels 13 may be formed in the intermediate metal film.

(c) In the fluid circuit unit 41 of the second embodiment, a metal film, such as a copper or stainless steel film, may be used as the flexible member 43.

(d) In the fluid circuit units 1 and 51 of the first and third embodiment, respectively, fluid channels may be provided in different, multiple-layered resin films in which the fluid channels at different levels may be connected to create a multiple-level fluid channel structure within the flexible member 4 or 52, respectively.

Having described the invention, what is claimed as new and desired to be secured by Letters Patent is:

1. A fluid manifold comprising,
a flexible member including a plurality of films bonded together by application of heat and pressure without use of any adhesive, the flexible member further including at least one fluid inlet, at least one fluid outlet, and at least one fluid channel for connecting the at least one fluid inlet to the at least one fluid outlet.

2. A fluid manifold in accordance with claim 1 further comprising at least one base, the flexible member being attached to a surface of the at least one base,
wherein the at least one fluid channel is formed within the flexible member and wherein the at least one base includes at least one admission port placed in communication with the at least one fluid inlet and at least one exhaust port placed in communication with the at least one fluid outlet.

3. A fluid manifold in accordance with claim 1, wherein the flexible member is formed by bonding together a plurality of resin films and the at least one fluid channel is formed in at least one of the resin films.

4. A fluid manifold in accordance with claim 1, wherein the flexible member is made of a resin selected from the group consisting of polyimides and polyether ether ketone (PEEK).

5. A fluid manifold in accordance with claim 1, wherein the flexible member is formed by bonding together a plurality of metal films and the at least one fluid channel is formed in at least one of the metal films.

6. A fluid manifold in accordance with claim 1, wherein the flexible member is made of a metal selected from the group consisting of copper and nickel.

7. A fluid manifold in accordance with any one of claim 1 further comprising one or more fluid control devices mounted on the flexible member.

8. A fluid manifold in accordance with claim 2, wherein the at least one base includes a first base and a second base, the first base containing the at least one admission port and the second base containing the at least one exhaust port.

9. A fluid manifold in accordance with claim 2, wherein the at least one base is made of a resin selected from the group consisting of polyimides and polyether ether ketone (PEEK).

10. A fluid manifold in accordance with claim 8, wherein the flexible member is adapted to be detachable from the second base by bending the flexible member.

11. A fluid manifold comprising,
a flexible member including at least one fluid inlet, at least one fluid outlet, and at least one fluid channel for connecting the at least one fluid inlet to the at least one fluid outlet, and
at least one base to a surface of which the flexible member is bonded by application of heat and pressure without using any adhesive,
wherein the at least one fluid channel is formed between the flexible member and the at least one base and the at least one base includes at least one admission port placed in communication with the at least one fluid inlet and at least one exhaust port placed in communication with the at least one fluid outlet.

12. A fluid manifold in accordance with claim 11, wherein the at least one fluid channel is formed in the surface of the at least one base and the flexible member includes a resin film covering the at least one fluid channel.

13. A fluid manifold in accordance with claim 11 further comprising one or more fluid control devices mounted on the flexible member.

14. A fluid manifold in accordance with claim 13, wherein the fluid control devices include valve members for opening and closing the at least one fluid channel and the flexible member includes valve seats thereon for receiving the valves.

15. A fluid manifold in accordance with claim 13 further comprising a wiring pattern provided on the flexible member for forming an electrical circuit for the fluid control devices.

16. A fluid manifold in accordance with claim 11, wherein the at least one base includes a first base and a second base, the first base containing the at least one admission port and the second base containing the at least one exhaust port.

17. A fluid manifold in accordance with claim 11, wherein the at least one base is made of a resin selected from the group consisting of polyimides and polyether ether ketone (PEEK).

18. A fluid manifold in accordance with claim 11, wherein the flexible member is made of a resin selected from the group consisting of polyimides and polyether ether ketone (PEEK).

19. A method for manufacturing a fluid manifold comprising the steps of:
bonding a plurality of films by application of heat and pressure without use of any adhesive to form a flexible member, and
providing at least one fluid inlet, at least one fluid outlet, and at least one fluid channel in the flexible member, the at least one fluid channel connecting the at least one fluid inlet to the at least one fluid outlet.

20. A method in accordance with claim 19 further comprising the step of attaching a surface of the flexible member to at least one base including at least one admission port for being in communication with the at least one fluid inlet and at least one exhaust port for being in communication with the at least one fluid outlet.

21. A method in accordance with claim 19, wherein the flexible member is formed by bonding together a plurality of resin films and the at least one fluid channel is formed in at least one of the resin films.

22. A method in accordance with claim 19, wherein the flexible member is made of a resin selected from the group consisting of polyimides and polyether ether ketone (PEEK).

23. A method in accordance with claim 19, wherein the flexible member is formed by bonding together a plurality of metal films and the at least one fluid channel is formed in at least one of the metal films.

24. A method in accordance with claim 19, wherein the flexible member is made of a metal selected from the group consisting of copper and nickel.

25. A method in accordance with claim 19 further comprising one or more fluid control devices mounted on the flexible member.

26. A method in accordance with claim 20, wherein the at least one base includes a first base and a second base, the first base containing the at least one admission port and the second base containing the at least one exhaust port.
